(19) United States
(12) Patent Application Publication
(10) Pub. No.: US 2004/0060404 A1
(43) Pub. Date: Apr. 1, 2004

(54) Breakaway hub for saw

(75) Inventor: James I. Metzger JR., Ballwin, MO (US)

Correspondence Address: HOWREY SIMON ARNOLD & WHITE LLP, ATTEN. DOCKETING DEPT. (A), 750 BERING DRIVE, HOUSTON, TX, 77057, US

(73) Assignee: Emerson Electric Co., St. Louis, MO (US)

(21) Appl. No.: 10/065,276

(22) Filed: Sep. 30, 2002

(51) Int. Cl. B26D 5/00

(52) U.S. Cl. 83/58; 83/835

(57) ABSTRACT

A blade assembly for a saw having a blade that rotates about an arbor includes a blade collar, first washer, saw blade, second washer, and arbor nut mounted onto the arbor. The first washer has integral shear pins that engage voids of the blade collar, coupling the blade collar to the first washer. To electrically isolate the saw blade, the first washer is made of an electrically insulating material, and also includes a hub that extends into the aperture of the blade, electrically insulating the blade from the arbor. The arbor nut secures the blade assembly to the arbor. Upon an emergency brake being applied to the blade, the shear pins shear, de-coupling the blade collar from the first washer, minimizing damage to the drive system and allowing for a rapid stop of the blade.

### BACKGROUND OF INVENTION

1. Field of the Invention

The present invention relates generally to a breakaway hub device for use on equipment having a rotating saw blade.

2. Description of the Related Art

Emergency brakes have been used on saws having a rotating blade for a variety of purposes, including preventing kickback of the workpiece and more particularly, preventing injury caused by human contact with the blade. A variety of mechanisms that sense human contact with the blade and/or sense the location of a human relative to the blade, are used to actuate an emergency braking device. These sensing mechanisms, include proximity sensors such as the capacitively coupled and laser detection type. Based on a predetermined signal from the sensing mechanism a fast acting blade brake, acting directly on the blade, is engaged to grasp the blade and stop its rotation. In these systems, during a sudden stop of the blade, large forces are created by the inertia of the drive system, such as motors, gears, or any other drive system that causes rotation of the blade. Although in a typical system power is removed from the drive system upon detection by the proximity sensors, these forces can still damage the drive system, such as bending or breaking the shaft or arbor, and damaging gears or the gear case of a motor. In addition, the large forces also cause the blade to stop less quickly and require a larger brake than if the forces were not present.

Moreover, drive systems that produce a larger torque require a larger, more massive, and costly braking system. These devices, may also require drive systems be modified with stronger internal parts in order to accommodate the large inertia acting on the system. The breakaway device of the present invention provides an inexpensive and direct solution to help prevent drive system damage, as well as reduce the braking force and time required to suddenly stop a rotating saw blade.

### SUMMARY OF INVENTION

In accordance with one embodiment of the present invention, a saw blade assembly includes an arbor that has a first blade collar mounted thereto. The several methods of mounting a blade collar to the arbor include, but are not limited to, keying the collar rotationally to the arbor, abutting the blade collar against a shoulder on the arbor, or pressing the blade collar onto the arbor so that the blade collar is securely mounted to the arbor. In this embodiment, a saw blade has an aperture that receives the arbor. A first washer is interposed between the first blade collar and the blade. At least one shear pin couples the first washer to the first blade collar. Rotation of the arbor, for example by a drive system, causes rotation of the blade assembly. Upon a sudden stop of the blade, such as by an emergency brake being applied to the blade, the shear pin fractures de-coupling the first washer from the first blade collar. The de-coupling of the first washer from the first blade collar results in the saw blade being substantially de-coupled from the mass of the arbor and the drive system, allowing for a more rapid stop of the blade.

In one exemplary aspect of an embodiment of the present invention, the blade assembly includes a fastener securing the blade assembly to the arbor, such as by a nut tightened onto a male threaded arbor or a screw threaded into a female threaded arbor. A further aspect of an embodiment of the present invention includes a second blade collar mounted on the arbor. The second blade collar can be mounted to the arbor by any suitable method, including keying the collar rotationally to the arbor or abutting the blade collar against a shoulder on the arbor. Still in another exemplary aspect of an embodiment of the present invention, a second washer abuts the opposite side of the first washer side of the saw blade and is interposed between the saw blade and the optional second blade collar. The nut or bolt engages the arbor threads securing the blade assembly to the arbor.

In still other exemplary embodiments of the present invention, the first blade collar has at least one void portion that can be a through void, such as a hole, or a partial void, such as a recess. The first washer has at least one integral shear pin that extends from the side of the first washer that is juxtaposed to the first blade collar. In such an embodiment, the shear pin extends from the first washer to engage the first blade collar's void, coupling the first washer to the first blade collar. In an alternative embodiment, both the first washer and the first blade collar each have at least one void portion, that receives a shear pin, coupling the first washer to the first blade collar. Still another aspect of the invention includes notch portions on both the first blade collar and the first washer. A shear key is placed within the notches coupling the first washer to the first blade collar.

Further exemplary embodiments of the present invention include a through void on the first washer. In a further alternative aspect of this embodiment, the shear pin has a head that has a larger perimeter than the first washer's through void, so that when assembled the shear pin abuts the blade side of the first washer, preventing any substantial movement of the shear pin.

Yet another aspect of an embodiment of the present invention includes a washer made of a low friction material being interposed between the first blade collar and the first washer. An alternative to inserting a washer is to apply a low friction material to either the first blade collar side of the first washer or the first washer side of the first blade collar. The low friction material provides an interface that minimizes the frictional torque between the first blade collar and the first washer, so that the stopping torque is transferred more reliably to the shear pin fracturing features of the present invention.

In still another aspect of an embodiment of the present invention, a washer made of a low friction material is interposed between the second blade collar and the second washer. An alternative to inserting a washer is to apply a low friction material to either the second blade collar side of the second washer or the second washer side of the second blade collar. The low friction material provides an interface that minimizes the frictional torque between the second blade collar and the second washer, so that the stopping torque is transferred more reliably to the shear pin fracturing features of the present invention.

In another aspect of an embodiment of the present invention, a washer made of a high friction material is interposed between the first washer and the saw blade. In the alternative, a high friction material is applied to either the first washer side of the saw blade or the saw blade side of the first washer. Applying the friction surface between the first washer and the saw blade also assists in transferring the stopping torque to the fracturing of the shear pins for better control of the breakaway torque.

In still a further exemplary aspect of an embodiment of the present invention, to electrically insulate the saw blade from the arbor, both the first and second washers are made of an electrically insulating material. The first washer has a hub that extends into the aperture of the blade, electrically insulating the blade from the arbor. This aspect of the invention is particularly useful in those saw blade emergency-braking systems that sense user contact or proximity to the blade, in order to actuate a blade brake.

Still in further exemplary embodiments of the present invention, both the first and second washers are made of an electrically insulating material and both the first and second washers each have hubs that extend into the aperture of the blade, electrically insulating the blade from the arbor. In another alternative aspect of the present invention, rather than the second washer having a hub that extends into the blade aperture, the second washer has an aperture larger than the outer perimeter of the first washer's hub. In this alternative embodiment, the hub of the first washer extends through the aperture of the blade into the aperture of the second washer, electrically insulating the saw blade from the arbor. In an alternative embodiment, the hub of the first washer has a threaded portion that extends through the blade aperture into the aperture of the second washer. The second washer is similar to a nut and has female threads. The female threaded second washer is tightened onto the first washer's threaded hub, electrically insulating the saw blade from the arbor.

In further exemplary embodiments of the present invention, both the first and second washers are made of an electrically insulating material. However, rather than the first washer having a hub that extends into the blade's aperture, the second washer has a hub that extends into the aperture of the blade, electrically insulating the blade from the arbor. In a further aspect of this embodiment, the first washer has an aperture that is larger than the outer perimeter of the second washer's hub. In this aspect, the hub of the second washer extends through the aperture of the blade into the aperture of the first washer. In still a further alternative aspect of this alternative embodiment of the present invention, the hub of the second washer has a threaded portion that extends through the blade aperture into the aperture of the first washer. The first washer is similar to a nut and has female threads. The female threaded first washer is tightened onto the second washer's threaded hub, electrically insulating the saw blade from the arbor.

Still in further exemplary embodiments of the present invention, any suitable means of coupling the first and second washer made of an electrically insulating material is considered, among other things, within an embodiment of the present invention. For example, rather than coupling the first and second washer using a threaded connection, the first washer or second washer could have slots that receive tabs extending from the second washer or first washer, respectively, thereby coupling the first washer to the second washer.

In a further exemplary embodiment of the present invention, both the first and second washers are made of an electrically insulating material. In this embodiment, the blade assembly further includes a disc made of an electrically insulating material. The saw blade had an enlarged aperture that securely receives the electrically insulating disc, and the disc has an aperture that receives the arbor, electrically insulating the blade from the arbor.

In yet another exemplary embodiment of the present invention, the arbor has a reduced diameter portion that is surrounded by a sleeve made of an electrically insulating material. Both the first and second washers are made of an electrically insulating material. The saw blade is mounted onto the electrically insulating sleeved portion of the arbor, electrically insulating the saw blade from the arbor. An arbor nut that has a recess portion is secured to the arbor. The recess portion of the arbor nut receives any overextended portion of the electrically insulating sleeve.

In another embodiment of the present invention, a washer made of a high friction material is interposed between the second washer and the saw blade. In the alternative, a high friction material is applied to either the second washer side of the saw blade or the saw blade side of the second washer.

In still a further exemplary embodiment of the present invention, the first blade collar and the saw blade each have at least one void portion. At least one shear pin is placed within the saw blade void. The shear pin extends from the void of the saw blade to engage the first blade collar's void, coupling the blade to the first blade collar. Upon a sudden blade stop, such as by an emergency brake acting on the blade, the shear pin fractures de-coupling the blade from the first blade collar. In a further aspect of this embodiment, a first washer having at least one through void is interposed between the first blade collar and the saw blade. The shear pin extends from the void of the saw blade, through the void of the first washer to engage the void of the first blade collar; thereby coupling both the blade and the first washer to the blade collar. Upon a sudden blade stop, the shear pin fractures de-coupling the blade from the first washer, or de-coupling the first washer from the first blade collar, or de-coupling both the blade and the first washer from the first blade collar.

### BRIEF DESCRIPTION OF DRAWINGS

Other objects and advantages of the invention will become apparent upon reading the following detailed description and upon reference to the drawings in which:

FIG. 1 is view of a typical prior art blade assembly for a miter saw.

FIG. 2 is a perspective view of a blade assembly in accordance with one embodiment of the present invention.

FIG. 2A is a rear view of a first washer shown in FIG. 2.

FIG. 2B is a front view of an alternative aspect of the first washer shown in FIG. 2.

FIG. 2C illustrates a side view of the assembled blade assembly shown in FIG. 2.

FIG. 3 is a perspective view of an embodiment of the blade assembly in accordance with one aspect of the present invention having a third washer.

FIG. 4 is a perspective view of a blade assembly having third and fourth washers in accordance with an embodiment of the present invention.

FIG. 5 is a perspective view of a blade assembly with the first washer having through holes and the shear pins having a pin head in accordance with an embodiment the present invention.

FIG. 6 is a perspective view of a blade assembly having a first washer with integral shear pins in accordance with an embodiment of the present invention.

FIG. 6A is a rear view of the first washer shown in FIG. 6.

FIG. 7 is a perspective view of a blade assembly having a saw blade with through holes in accordance with an embodiment of the present invention.

FIG. 8 is a perspective view of a blade assembly having the saw blade electrically insulated from the saw arbor in accordance with an embodiment of the present invention.

FIGS. 9-11 are perspective views of an alternative design of the first and second washers to electrically insulate the saw blade from the arbor in accordance with an embodiment of the present invention.

FIG. 11A is a rear view of the second washer shown in FIG. 11.

FIG. 12 shows a blade assembly with the saw blade having a disc that assists in electrically insulating the saw blade from the arbor in accordance with an embodiment of the present invention.

FIG. 13 shows a side view of a blade assembly with an arbor having an insulated reduced diameter portion as an embodiment of the present invention.

While the invention is susceptible to various modifications and alternative forms, specific embodiments thereof have been shown by way of example in the drawings and are herein described in detail. It should be understood however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nonetheless be a routine undertaking for those of ordinary skill in the art having the benefit of this disclosure.

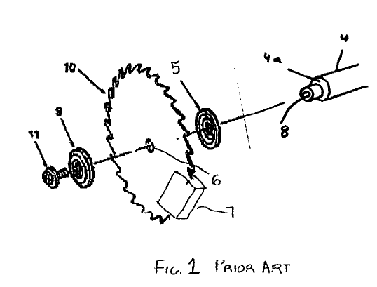

Turning to the drawings, FIG. 1 illustrates a typical prior art blade assembly for a miter saw. The blade assembly includes a saw blade 10 having an aperture through which a saw arbor 4 is placed. The blade assembly includes an arbor 4 with a female threaded end 8; a first blade collar 5 that fits on and is rotationally keyed to the arbor 4; a saw blade 10 interposed between the fist blade collar 5 and a second blade collar 9 that fits on and is rotationally keyed to the arbor 4; and an arbor screw 11. The first blade collar 5 is placed between a shoulder 4a on the arbor 4 and the saw blade 10, and the second blade collar 9 is placed between the saw blade 10 and the arbor screw 11. Also shown in FIG. 1 is an emergency brake 7 designed to grasp the saw blade 10 and hold it in a locked position, preventing rotational movement, when a sudden or emergency stop of the blade 10 is required. It can be appreciated that the emergency brake can include the type described in U.S. Pat. Nos. 3,785,230 and 4,026,177 to Lokey, or other similar devices. These devices are designed to stop the rotational movement of the saw blade 10 upon receiving a signal for an emergency stop, such as human contact with the blade 10.

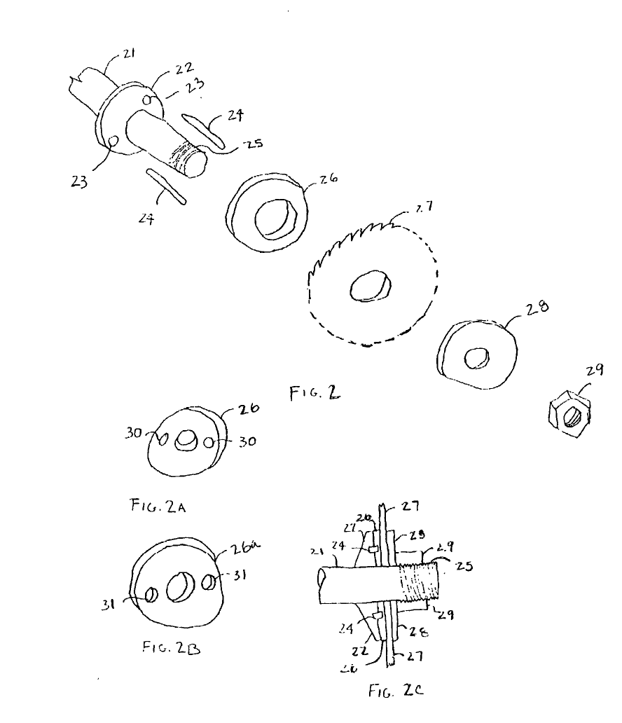

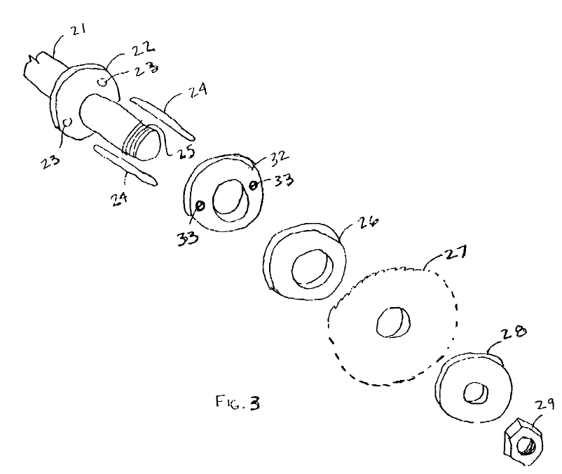

FIG. 2 depicts a blade assembly for equipment having a rotating blade embodying one embodiment of the present invention. In this embodiment, the blade assembly includes an arbor 21 having a first blade collar 22, a first washer 26, a saw blade 27, a second blade collar 28, and a means for securing the blade assembly to the arbor such as a nut 29, as shown, screw, or any suitable fastening mechanism. The arbor 21 defines the rotational axis of the saw blade 27 and allows the blade 27 to rotate around its axis. As shown, the arbor 21 has a threaded end 25 that can be either male and accept a nut or female and receive a screw. As shown in FIG. 2, the arbor 21 has a male threaded end 25 with a nut 29 mounted thereto. The first blade collar 22 is mounted to the arbor 21, such as by pressing the first blade collar 22 onto the arbor 21. The first blade collar 22 has two void portions 23, which allow it to receive shear pins 24. The first washer 26, second blade collar 28, saw blade 27 and arbor nut 29 are mounted onto the arbor 21. The rear of first washer 26, as shown in FIG. 2A, has two void portions 30 that receive the shear pins 24 and mate with the first blade collar void portions 23. The shear pins 24 are shaped to engage the voids 23, 30 of the first blade collar 22 and the first washer 26, respectively. The saw blade 27 is interposed between the first washer 26 and the second blade collar 28. The arbor nut 29 is tightened onto the arbor's threaded end 25 with sufficient force to assure rotation of the blade during normal use.

As depicted in the side view of the blade assembly shown in FIG. 2C, the first blade collar 22 and first washer 26 are coupled to substantially enclose the shear pins 24. During normal operation of the saw, a drive system (not shown) rotates the arbor 21 causing the saw blade 27 to rotate with the arbor 21. If something causes the saw blade 27 to stop suddenly, for example, the emergency brake 7 shown in FIG. 1, the shear pins 24 fracture because of the substantial inertia force caused by the brake grasping the saw blade 27. The shearing of the shear pins 24, de-couples the first washer 26 from the first blade collar 22, thus de-coupling the saw blade 27 from the rotational force of the arbor 21, while safely retaining the saw blade 27 on the arbor 21. Although some frictional coupling remains, this de-coupling reduces the forces on the drive system when the blade is suddenly stopped and reduces the requisite amount of mass to be stopped by the emergency brake. Because the emergency brake has a reduced mass to stop, the required emergency brake is much smaller and less massive. De-coupling the saw blade 27 from the arbor 21 also minimizes potential damage to the drive system and the arbor 21, and allows the emergency brake to stop the saw blade 27 faster. This design also allows for a rapid blade brake without necessarily stopping the entire drive system so quickly. Upon shearing or fracturing of the shear pins 24, the blade assembly can be disassembled and the shear pins 24 and first washer 26 replaced for continued operation.

Although the void portions 23, 30 of both the first blade collar 22 and the first washer 26 are shown as only partial voids, the void portions 23, 30 can be through holes or voids, notches, and/or partially hollow recesses, so that when the blade assembly is assembled, the shear pins 24 engage the void portions 23, 30 of the first blade collar 22 and the first washer 26. Referring to FIG. 2B, a front view of an alternative first washer 26a is shown. In FIG. 2B, the first washer 26a is shown with through holes 31 so that the shear pins 24 extend through the holes 31 of the first washer 26a. The first blade collar 22, first washer 26a, second blade collar 28, and shear pins 24 can be designed to accommodate a myriad of rotational saw blade applications.

The shear pins 24 are designed to shear or fracture based on the drive systems maximum rated torque, along with the weight and rotational forces of the blade assembly. Other factors that determine the shearing strength required for the shear pins design vary depending on the application. For example, desired stopping time of the blade, the maximum torque under normal operating conditions in order to prevent nuisance shearing of pins (i.e. accommodate saw blade hitting knots in wood, etc), and the maximum permissible torque to prevent damage to drive system.

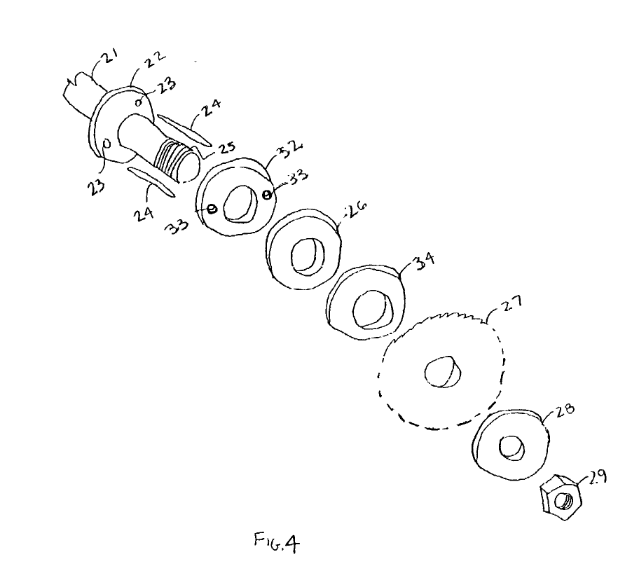

In other embodiments, such as that shown in FIG. 3, friction between the first blade collar 22 and the first washer 26 is reduced to minimize the frictional torque between the first blade collar 22 and the first washer 26. In the exemplary embodiment shown in FIG. 3, the friction is reduced via a third washer 32 interposed between the first blade collar 22 and the first washer 26. The third washer 26 is made of a low friction material, such as Teflon, for example, or any other suitable material.

The third washer 32 has through holes 33 to receive the shear pins 24 and allow the shear pins 24 to engage the partial voids 30 on the rear of the first washer 26, as previously shown in FIG. 2A. In addition, the third washer 32 assists in transferring the stopping torque to the breakaway features of the shear pins 24 for better control of the breakaway torque. Many alternatives to inserting the third washer 32 are contemplated. For example, rather than inserting the third washer 32 between the first blade collar 22 and the first washer 26, a low friction material can be applied to the side of the first washer 26 juxtaposed to the first blade collar 22; and/or a low friction material can be applied to the side of the first blade collar 22 juxtaposed to the first washer 26.

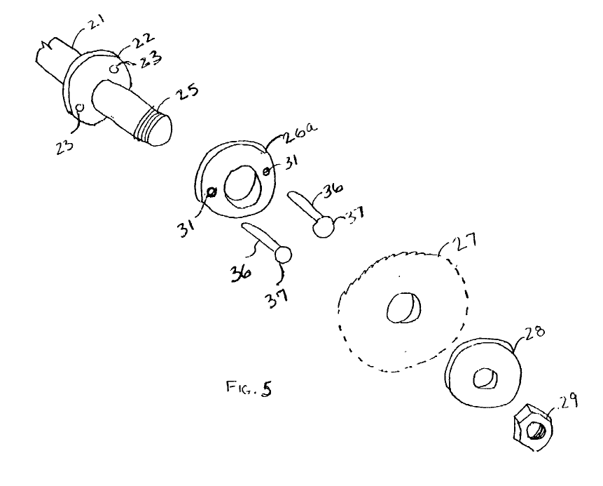

In accordance with still further embodiments of the present invention, FIG. 4 depicts the blade assembly that includes increased frictional torque between the first washer 26 and the saw blade 27. This assists in transferring the stopping torque to the breakaway features of the shear pins 24 for better control of the breakaway torque. The embodiment illustrated in FIG. 4 includes a fourth washer 34 interposed between the first washer 26 and the saw blade 27 to increase the friction therebetween. The fourth washer 34 is made of a high friction material, such as a cork-rubber composite, for example, or any other suitable material. The high friction material fourth washer 34 placed between the first washer 26 and the saw blade 27 may be used alone (i.e. without low-friction third washer 32) or in combination with the low friction third washer 32 placed between the first blade collar 22 and the first washer 26 to further assist in transferring the stopping torque to the breakaway features of the shear pins 24 for better control of the breakaway torque.

Many alternatives to inserting the fourth washer 34 are contemplated. For example, rather than inserting the high friction material fourth washer 34 between the first washer 26 and the saw blade 27, a high friction material can be applied to the side of the first washer 26 juxtaposed to the saw blade 27; and/or a high friction material can be applied to the side of the saw blade 27 juxtaposed to the first washer 26.

In still a further aspect of this embodiment, a fifth washer (not shown) made of a low friction material is placed between the second blade collar 28 and the saw blade 27. This embodiment is particularly useful when the second blade collar 28 is rotationally keyed to the arbor 21. The fifth washer made of a low friction material minimizes the frictional torque between the second blade collar 28 and the saw blade 27. The fifth washer made of a low friction material assists in transferring the stopping torque to the breakaway features of the shear pins 24 for better control of the breakaway torque. Although the use of fifth washer is described, rather that using a fifth washer made of a low friction material a low friction material can be applied to the second blade collar 28 side of the blade 27, and/or a low friction material can be applied to the blade 27 side of the second blade collar 28.

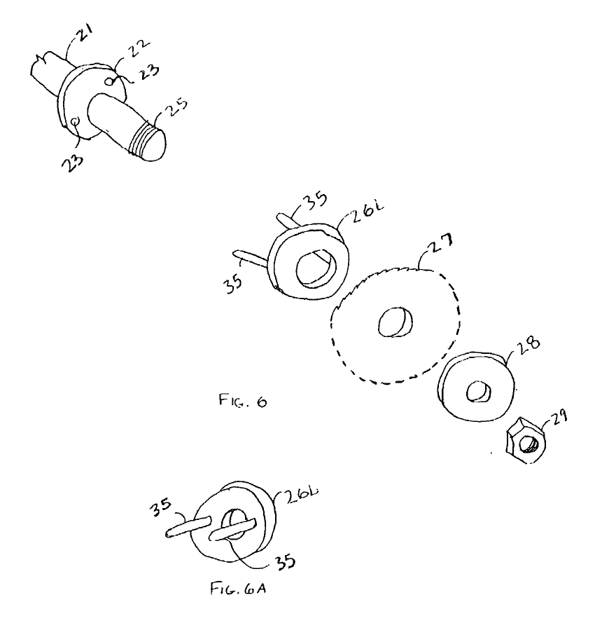

Turning to FIG. 5, in yet another alternative embodiment of the present invention, the blade assembly is shown with the male threaded arbor 21, the first blade collar 22 with partially void recesses 23, first washer 26a as previously shown in FIG. 2B with through holes 31, the saw blade 27 interposed between the first washer 26a and the second blade collar 28, shear pins 36, and the arbor nut 29 securing the blade assembly to the threaded arbor 21. In this embodiment each of the shear pins 36 has a pin head 37. The shear pins 36 are placed on the blade side of the first washer 26a and extend through the first washer holes 31 into the first blade collar recesses 23 so that the pin heads 37 abut the saw blade 27. As shown, the first blade collar 22 has partially void recesses 23, however the first blade collar 22 could also have through holes. The heads 37 of the shear pins 36 have a larger diameter than that of the first washer holes 31, so that the shear pins 36 are incapable of sliding out of the first washer 26a when the blade assembly is assembled. As in the previous embodiments, upon a sudden stop of the blade 27, the shear pins 36 fracture, allowing the blade 27 to break free from the drive system and providing for a rapid stop of the blade 27.

In another alternative embodiment, FIG. 6 illustrates a blade assembly with first washer 26b having integral shear pins 35. A rear view of the first washer 26b depicting the integral shear pins 35 is shown in FIG. 6A. As in the previous embodiments, the integral shear pins 35 are shaped to engage the recess voids 23 of the first blade collar 22, coupling the first blade collar 22 to the first washer 26b. Upon a sudden stop causing the shear pins 35 to fracture, the entire first washer 26b with the integral shear pins 35 can be replaced.

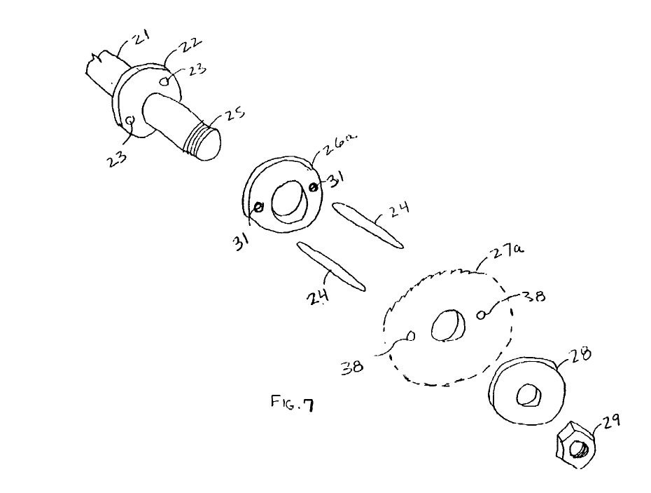

Another embodiment of the present invention is shown in FIG. 7. The blade assembly includes the male threaded arbor 21, first blade collar 22, first washer 26a, the saw blade 27a interposed between the first washer 26a and the second blade collar 28, shear pins 24 and the arbor nut 29 securing the blade assembly to the arbor 21. In this embodiment, the first blade collar 22 has partial recess voids 23, the first washer 26a has through hole voids 31, and the saw blade 27a has through holes 38. The shear pins 24 extend through the holes of the saw blade 38, into the first washer holes 31 and into the first blade collar recesses 23. The shear pins 24 do not have pin heads, as previously shown in FIG. 5, rather when the blade assembly is assembled the shear pins 24 are substantially enclosed, and the second blade collar 28 prevents any substantial movement of the shear pins 24. In the alternative the shear pins 24 can have a pin head, such as the shear pins 36 shown in FIG. 5, that has a larger than the diameter of the saw blade voids 38 in order to prevent the shear pins 24 from sliding out of place when the blade assembly is coupled together, this alternative is particularly useful if the first blade collar voids 23 were also through hole voids.

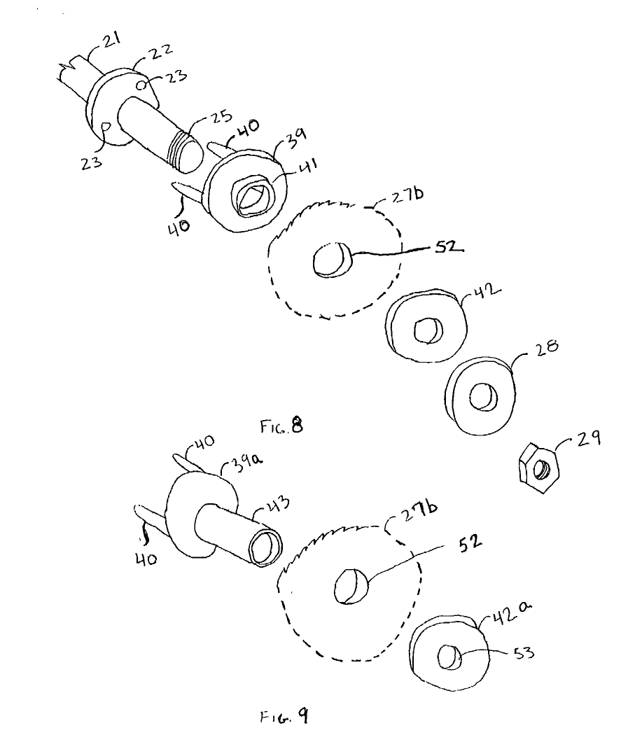

Turning to FIG. 8, in a saw with energy applied to the blade, such as capacitively coupled electronic signals for detecting user contact or proximity relative to the saw blade, the saw blade assembly of the present invention has a breakaway hub design that is made of an electrically insulating material, eliminating the need to electrically isolate the entire arbor in order to energize the blade with a signal. In this embodiment, the blade assembly includes the first blade collar 22 secured to the male threaded arbor 21, a saw blade 27b with an enlarged aperture 52, a first and second washer 39,42 that are made of an electrically insulating material, the second blade collar 28 and the arbor nut 29. The electrically insulating material can include materials such as polyester plastic or any other suitable materials. As shown, the first blade collar 22 has multiple void spaces 23 and the rear side of the first washer 39 has integral shear pins 40 that engage the void spaces 23 of the first blade collar 22 when the blade assembly is assembled. On the opposite side of the first washer 39 is a hub 41 that extends into the aperture 52 of the saw blade 27b electrically isolating the saw blade 27b from the arbor 21. Although in this embodiment the first washer 39 is made of an electrically insulating material, because of the various shear strength requirements for the shear pins 40, the shear pins 40 can be made of a conductive material or an electrically insulating material.

When the blade assembly shown in FIG. 8 is assembled, the first washer 39 is slid onto the arbor 21, the shear pins 40 extend from the first washer 39 into the void spaces 23 of the first blade collar 22, coupling the first washer 39 to the first blade collar 22. Next, the saw blade 27b is slid onto the arbor 21 and mounted upon the first washer's hub 41, the second washer 42 is then slid onto the arbor 21, the second blade collar 28 is mounted to the arbor 21, and the arbor nut 29 tightened onto the threaded end 25 of the arbor 21, securing the blade assembly to the arbor 21 and electrically insulating the saw blade 27b from the arbor 21. Although FIG. 8 depicts the first washer 39 with its hub 41 extending into the blade's aperture 52, it can be appreciated that in the alternative, the second washer 42, rather that the first washer 39, can have a hub that extends into the blade's aperture 52 electrically insulating the blade 27b from the arbor 21. As previously mentioned, upon a sudden stop of the blade 27b, the shear pins 40 shear or fracture de-coupling the first washer 39 from the first blade collar 22, thereby allowing a rapid stop of the blade 27b by an emergency brake (not shown), and preventing damage to the drive system (not shown).

As mentioned in previous alternative embodiments, in order to assist in transferring the stopping torque to the breakaway features of the shear pins 40 for better control of the breakaway torque, alternatives to the embodiment shown in FIG. 8 can include the following: the addition of a third washer made of a low friction material interposed between the first blade collar 22 and the first washer 39; the addition of a fourth washer made of a high friction material interposed between the first washer 39 and the saw blade 27b; and/or the addition of a fifth washer made of a low friction material interposed between the second washer 42 and the second blade collar 28. Rather than having separate third, fourth, and/or fifth washers, in the alternative: the first washer 39 and/or the first blade collar 22 can have a low friction substance applied directly their respective juxtaposing sides; the first washer 39 and/or the saw blade 27b can have a high friction substance directly applied their respective juxtaposing sides; and/or the second washer 42 and/or the second blade collar 28 can have a low friction substance directly applied to their respective juxtaposing sides.

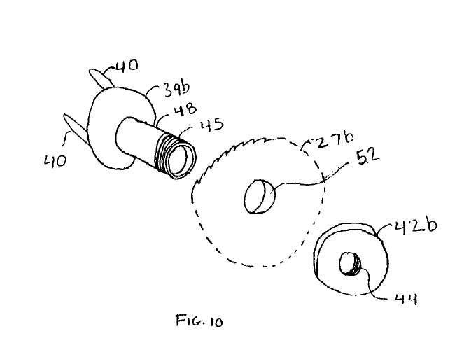

Turning to FIG. 9, other alternatives for electrically insulating the saw blade 27b from the arbor 21 are shown. In FIG. 9, a perspective view of an alternative design of the first and second washers 39a, 42a is shown. In this embodiment the first and second washers 39a, 42a are made of an electrically insulating material. The first washer 39a has a longer hub 43 than the hub 41 previously shown in FIG. 8 and the second washer 42a has a larger aperture 53 than the aperture of the second washer 42 previously shown in FIG. 8. The first washer's hub 43 extends through the aperture 52 of the saw blade 27b into the larger aperture 53 of the second washer 42a electrically insulating the blade 27b from the arbor 21. Although FIG. 9, depicts the first washer 39a with a hub 43 extending into the blade's aperture 52 and into the hub 53 of the second washer 42a, it can be appreciated that in the alternative, the second washer 42a, rather that the first washer 39a, can have a hub that extends into the blade's aperture 52 and the first washer 39a electrically insulating the blade 27b from the arbor 21.

Still another alternative design for electrically insulating the saw blade 27b from the arbor 21 as an embodiment of the present invention is shown in FIG. 10. FIG. 10 illustrates the first and second washers 39b, 42b that are made of an electrically insulating material. The first washer 39b has an extended hub 48 with a male threaded end 45. The second washer 42b has inner threads 44, such as those of a nut. When assembled, the threaded hub 48 of the first washer 39b extends through the aperture 52 of the saw blade 27b into the inner threads 44 of the second washer 42b. The inner threads 44 of the second washer 42b are threaded onto the threaded end 45 of the first washer hub 48 securing the second washer 42b to the first washer 39b and electrically insulating the saw blade 27b from the arbor 21. Although FIG. 10, depicts the first washer 39b with a threaded hub 48 extending into the blade's aperture 52 and the second washer 42b having inner threads 44 that receive the first washer's hub 48, it can be appreciated that in the alternative, the second washer 42b, rather that the first washer 39b, can have a threaded hub that extends into the blade's aperture 52 and the first washer 39b can have inner threads that receive the second washer's hub, electrically insulating the blade 27b from the arbor 21.

In addition, although FIG. 10 depicts the first washer 39b and the second washer 42 being coupled using threads, further embodiments of the present invention, include any suitable means of coupling the first washer 39b and the second washer 42. For example, rather than coupling the first washer 39b and the second washer 42 using a threaded connection, the first washer 39b or the second washer 42 could have slots that receive tabs extending from the second washer 42 or the first washer 39b, respectively, thereby coupling the first washer 39b to the second washer 42.

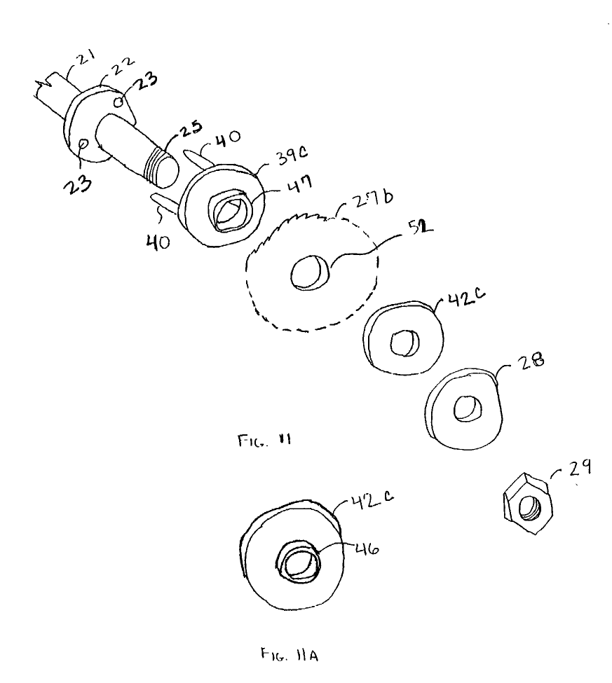

Still another alternative embodiment of the present invention is shown in FIGS. 11 and 11A. The blade assembly shown in FIG. 11 illustrates the male threaded end 25 arbor 21, the first blade collar 22 secured to the arbor 21, the first blade collar 22 having voids 23, first washer 39c with integral shear pins 40 that engage the voids 23 of the first blade collar 22, a saw blade 27b interposed between the first washer 39c and a second washer 42c, the saw blade 27b having an aperture 52, the second blade collar 28 mounted to the arbor 21, and the arbor nut 29 tightened onto the threaded arbor 21 to secure the blade assembly to the arbor 21. The first and second washers 39c, 42c are made of an electrically insulating material. The first washer 39c has a short hub 47 that extends into the aperture 52 of the saw blade 27b. A rear view of the second washer 42c is shown in FIG. 11A. As shown the second washer 42c also has a short hub 46 that extends into the aperture 52 of the blade 27b. When assembled the saw blade 27b is electrically insulated from the arbor 21. As in the previous embodiments, upon an emergency blade brake being applied to the saw blade 27b, the shear pins 40 fracture de-coupling the first blade collar 22 from the first washer 39c, allowing rapid stop of the blade 27b.

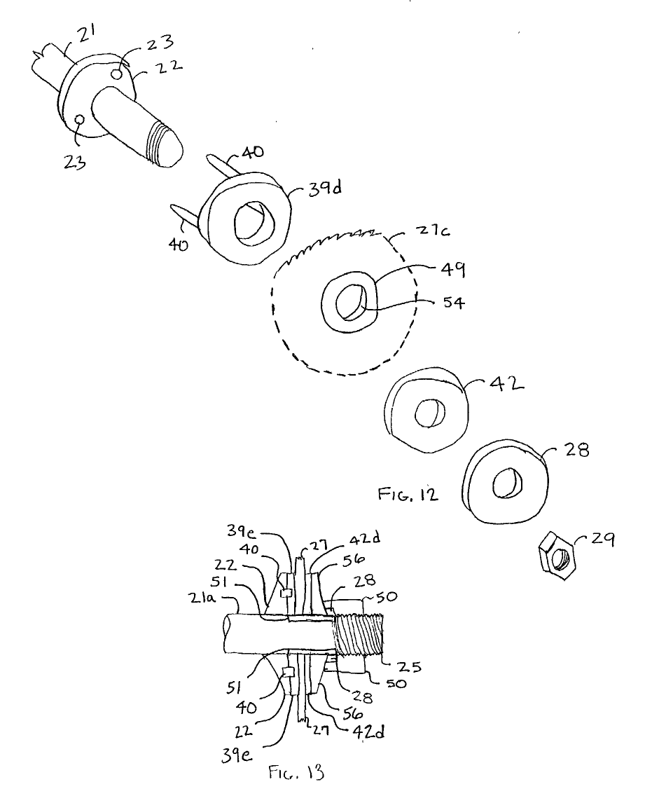

Still another alternative embodiment of the present invention is shown in FIG. 12. The blade assembly includes male threaded end 25 arbor 21, the first blade collar 22 having voids 23, the first blade collar 22 secured to the arbor 21, first and second washers 39d, 42 made of an electrically insulating material, the first washer 39d has integral shear pins 40 that engage the voids 23 of the first blade collar 22. The blade assembly further includes a saw blade 27c with an enlarged aperture that receives a disc 49, and the second blade collar 28 mounted to the arbor 21. The arbor nut 29 secures the blade assembly to the arbor 21. The disc 49 is made of an electrically insulating material and has an aperture 54 that receives the arbor 21. The disc 49 is manufactured and made of a material with physical properties strong enough to withstand the weight of the blade 27c, without causing pre-mature failure. The disc 49 is securely inserted into the aperture of the saw blade 27c, electrically insulating the saw blade 27c from the arbor 21. Upon a sudden stop of the blade 27c, the shear pins 40 fracture, de-coupling the first blade collar 22 from the first washer 39d, while the disc 49 remains secured in the blade's aperture.

Turning to FIG. 13, in another embodiment of the present invention, the blade assembly includes an arbor 21a with its threaded male end 25, the first blade collar 22 having multiple voids 23, a first washer 39e made of an electrically insulating material, shear pins 40 that engage the first washer 39e and the first blade collar voids 23 coupling the first washer 39e to the first blade collar 22 so that the shear pins 40 are substantially enclosed. The blade assembly also includes the saw blade 27 interposed between the first washer 39e and a second washer 42d also made of an electrically insulating material. The second blade collar 28 is mounted onto the arbor 21. An arbor nut 50 is tightened onto the male threaded end 25 of the arbor 21a to secure the blade assembly to the arbor 21a. In this embodiment, in order to accommodate standard size blades, while also electrically insulating the saw blade 27 from the arbor 21a, a portion of the arbor 21a has a reduced diameter. Surrounding the reduced diameter portion of the arbor 21a is a sleeve 51 made of an electrically insulating material that can be slipped, wrapped around, pressed, slid or made to contact the reduced diameter portion of the arbor 21a by any suitable means. Upon assembly, the saw blade 27, and a portion of the first washer 39e, the second washer 42d and the second blade collar 28 are mounted onto the sleeved reduced diameter portion of the arbor 21a, thereby electrically insulating the saw blade 27 from the arbor 21a. In the alternative it can be appreciated that to minimize the portion of the arbor 21a having the reduced diameter, only the portion of the arbor 21a with the saw blade 27 mounted thereto has the reduced diameter and the electrically insulating sleeve 51, thereby electrically insulating the saw blade 27 from the arbor 21a.

In a further aspect of the present invention depicted in FIG. 13, the arbor nut 50 has a recess portion 55 to receive any excess portion of the insulating sleeve 51. Although the threaded end 25 portion of the arbor 21a shown in FIG. 13 is not reduced, in order to allow the insulating sleeve to be slid onto the arbor 21a, the threaded end 25 could also have a reduced diameter. As in the previous embodiments, upon a sudden stop of the blade 27, the shear pins 40 shear or fracture de-coupling the first washer 39e from the first blade collar 22, thereby allowing a rapid stop of the blade 27 by an emergency brake (not shown), and preventing damage to the drive system (not shown).

Although the foregoing embodiments referenced shear pins, it can be appreciated that in other aspects of the present invention, rather than using shear pins, a shear key is used to couple the first blade collar to the first washer. Moreover with respect to the addition of low friction and/or high friction materials and/or washers interposed between various elements, it can also be appreciated that it is within the scope of this invention that the embodiments can include the addition of third, fourth, and/or fifth washers or substances made of low friction and/or high friction materials. Further, any suitable method of mounting the blade collars to the arbor are within the scope of the present invention, including keying the collar rotationally to the arbor, abutting the blade collar against a shoulder on the arbor, and pressing the blade collar onto the arbor so that the blade collar is securely mounted to the arbor.

In addition, although the use of the second blade collar 28 has been described herein, other embodiments of the present invention include the absence of the second blade collar 28. The omission of the second blade collar is particular useful in applications where the thickness of the first washer, second washer, and/or the thickness of the blade, for example with molding heads or dado blades, prevent the use of the second blade collar.

Further, although FIGS. 2-13 illustrate the first blade collar coupled to the first washer using a shear pin, being mounted to the arbor on the drive end of the saw blade assembly, and the second washer and second blade collar being mounted on the fastener end of the saw blade assembly, it is within the scope of embodiments of the present invention that the a shear pin couples the second washer and second blade collar on the fastener end of the saw blade. In this aspect, upon a sudden stop of the saw blade, the shear pin coupling the second washer and second blade collar shears, thereby de-coupling the second washer from the blade collar and thus decoupling the saw blade from the mass of the blade assembly. Moreover, the designation of first, second, third, fourth, fifth, and sixth, are not intended to limit the present invention to specific numerical designations, rather the numerical designations are used simply identify the various elements for clarity.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A saw blade assembly comprising:
an arbor;
a first blade collar mounted to the arbor;
a saw blade having an aperture receiving the arbor;
a first washer interposed between the first blade collar and the blade; and at least one shear pin coupling the first washer to the first blade collar,
wherein upon a sudden blade stop the shear pin fractures to de-couple the first washer from the first blade collar.

2. The saw blade assembly of claim 1 further comprising a fastener for securing the saw blade and the first washer to the arbor.

3. The saw blade assembly of claim 2, wherein the arbor has a threaded female end and the fastener includes a screw threaded into the arbor.

4. The saw blade assembly of claim 2, wherein the arbor has a threaded male end and the fastener includes a threaded nut tightened onto the arbor.

5. The saw blade assembly of claim 4, wherein the first washer is made of an electrically insulating material, the first washer further comprising a hub extending into the aperture of the blade, the nut having an electrically insulating material applied to its surface on the side of the nut in contact with the blade, electrically insulating the blade from the arbor.

6. The saw blade assembly of claim 1 wherein the first blade collar defines at least one void therein, the shear pin being integral to the first washer, the shear pin extending from the side of the first washer that is juxtaposed to the first blade collar into the first blade collar void.

7. The saw blade assembly of claim 1 wherein the first washer and the first blade collar each have at least one void receiving the shear pin.

8. The saw blade assembly of claim 7, wherein the voids of the first blade collar and the first washer are notches and the shear pin is a key.

9. The saw blade assembly of claim 7, wherein the voids of the first blade collar and the first washer are holes.

10. The saw blade assembly of claim 7, wherein the void of the first washer is a through void.

11. The saw blade assembly of claim 10, wherein the shear pin further comprises a head having a larger perimeter than that of the through void, the shear pin being placed within the blade assembly with the shear pin head abutting the blade side of the first washer.

12. The saw blade assembly of claim 1 further comprising a low friction material applied to at least one of the first blade collar side of the first washer or the side of the first blade collar juxtaposed to the first washer.

13. The saw blade assembly of claim 1 further comprising a third washer made of a low friction material, the third washer being interposed between the first blade collar and the first washer.

14. The saw blade assembly of claim 1 further comprising a high friction material applied to at least one of the portion of the blade juxtaposed to the first washer or the blade side of the first washer.

15. The saw blade assembly of claim 1, further comprising a fourth washer made of a high friction material, the fourth washer being interposed between the blade and the first washer.

16. The saw blade assembly of claim 1, wherein the first blade collar is mounted to the arbor in a keyed relationship.

17. The saw blade assembly of claim 1, wherein the first blade collar is pressed onto the arbor.

18. The saw blade assembly of claim 1, further comprising a second washer juxtaposed the opposite side of the first washer side of the saw blade.

19. The saw blade assembly of claim 18, wherein the first and second washers are made of an electrically insulating material, the first washer further comprising a hub extending into the aperture of the blade, electrically insulating the blade from the arbor.

20. The saw blade assembly of claim 19, wherein the second washer further comprises a hub extending into the aperture of the blade.

21. The saw blade assembly of claim 19, wherein the second washer has an aperture larger than the outer perimeter of the first washer's hub, and the hub of the first washer further extends into the aperture of the second washer.

22. The saw blade assembly of claim 21, wherein the hub of the first washer further comprises a threaded portion extending through the aperture of the blade, and the second washer further comprises inner threads, wherein the second washer is tightened onto the hub of the first washer.

23. The saw blade assembly of claim 18, wherein the first and second washers are made of an electrically insulating material, the second washer further comprises a hub extending into the aperture of the blade, electrically insulating the blade from the arbor.

24. The saw blade assembly of claim 23, wherein the first washer has an aperture larger than the outer perimeter of the second washer's hub, and the hub of the second washer further extends into the aperture of the first washer.

25. The saw blade assembly of claim 24, wherein the hub of the second washer further comprises a threaded portion extending through the aperture of the blade, and the first washer further comprises inner threads, wherein the first washer is tightened onto the hub of the second washer.

26. The saw blade assembly of claim 18, wherein the first and second washers are made of an electrically insulating material, the blade assembly further comprising an electrically insulating disc having an aperture receiving the arbor, the disc securely mounted within the blade aperture, electrically insulating the blade from the arbor.

27. The saw blade assembly of claim 18, wherein the second washer is a second blade collar.

28. The saw blade assembly of claim 27, wherein the second blade collar is mounted to the arbor in a keyed relationship.

29. The saw blade assembly of claim 18 further comprising a low friction material applied to at least one of the blade side of the second washer or the side of the blade juxtaposed to the second washer.

30. The saw blade assembly of claim 18 further comprising a fifth washer made of a low friction material, the fifth washer being interposed between the blade and the second washer.

31. The saw blade assembly of claim 19 further comprising:
a second blade collar mounted to the arbor; and
a fastener for securing the saw blade and the first washer to the arbor,
wherein the second blade collar is interposed between the second washer and the fastener.

32. The saw blade assembly of claim 31 further comprising a low friction material applied to at least one of the second blade collar side of the second washer or the side of the second blade collar juxtaposed to the second washer.

33. The saw blade assembly of claim 31 further comprising a sixth washer made of a low friction material, the sixth washer being interposed between the second washer and the second blade collar.

34. A saw blade assembly comprising:
an arbor having a reduced diameter portion;
an electrically insulating sleeve surrounding at least the reduced diameter portion of the arbor;
a first blade collar mounted to the arbor;
a saw blade having an aperture receiving the arbor, the saw blade mounted onto the electrically insulated reduced diameter portion of the arbor;
a first washer interposed between the first blade collar and the blade, the first washer being made of an electrically insulating material;
at least one shear pin coupling the first washer to the first blade collar; and
a fastener securing the saw blade to the arbor, wherein upon a sudden blade stop the shear pin fractures to de-couple the first washer from the first blade collar.

35. The saw blade assembly of claim 34, wherein the arbor has a threaded female end and the fastener includes a screw threaded into the arbor.

36. The saw blade assembly of claim 35, wherein the screw has an electrically insulating material applied to its underside portion.

37. The saw blade assembly of claim 34, wherein the arbor has a threaded male end and the fastener includes a threaded nut tightened onto the arbor.

38. The saw blade assembly of claim 37, wherein the nut has a recess portion to receiving any overextending portion of the electrically insulating sleeve.

39. The saw blade assembly of claim 37, wherein an electrically insulating material is applied to the side of the nut that is juxtaposed the saw blade.

40. The saw blade assembly of claim 34 further comprising a second washer interposed between the saw blade and the fastener.

41. The saw blade assembly of claim 40, wherein the second washer is made of an electrically insulating material.

42. The saw blade assembly of claim 40, wherein the second washer is a second blade collar.

43. The saw blade assembly of claim 42, wherein the second blade collar is mounted to the arbor in a keyed relationship.

44. A saw blade assembly comprising:
an arbor;
a saw blade having an aperture receiving the arbor, the saw blade having at least one void; and
a first blade collar mounted to the arbor, the first blade collar juxtaposed the saw blade, the side of the first blade collar juxtaposed the saw blade having at least one void; and
at least one shear pin placed within the saw blade void extending into the first blade collar void, coupling the blade to the first blade collar, wherein upon a sudden blade stop the shear pin fractures to de-couple the blade from the first blade collar.

45. The saw blade assembly of claim 44, further comprising a first washer interposed between the first blade collar and the blade, the first washer having at least one through void, wherein the shear pin within the saw blade void extends through the first washer void into the first blade collar.

46. The saw blade assembly of claim 44 further comprising a fastener securing the saw blade to the arbor.

47. The saw blade assembly of claim 46 further comprising a second washer interposed between the saw blade and the fastener.
